(19) United States
(12) Patent Application Publication
(10) Pub. No.: US 2025/0237864 A1
(43) Pub. Date: Jul. 24, 2025

(54) OPTICAL DEVICE FOR AUGMENTED REALITY INCLUDING POLARIZING PLATE

(71) Applicant: LETINAR CO., LTD, Anyang-si, Gyeonggi-do (KR)

(72) Inventors: Se Hyun PARK, Anyang-si, Gyeonggi-do (KR); Young Sun YUN, Anyang-si, Gyeonggi-do (KR)

(73) Assignee: LETINAR CO., LTD, Anyang-si, Gyeonggi-do (KR)

(21) Appl. No.: 18/841,287

(22) PCT Filed: Feb. 2, 2023
(86) PCT No.: PCT/KR2023/001545

§ 371 Date: Mar. 25, 2025

(30) Foreign Application Priority Data
Feb. 25, 2022 (KR) 10-2022-0025390

(51) Int. Cl. G02B 27/01

(52) U.S. Cl. CPC G02B 27/0101

(57) ABSTRACT

The present invention provides an optical device for augmented reality, the optical device including: an optical means for transferring real object image light, output from a real object, to the pupil of an eye of a user by transmitting it therethrough; a reflective unit embedded and disposed inside the optical means, and formed of a plurality of reflective modules that provide a virtual image to the user by transferring virtual image light, transferred from an image output unit, to the pupil of the eye of the user; and a polarizing plate configured to transmit therethrough only a polarization component in a first direction out of the real object image light; wherein the optical means has a first substrate having a plurality of unit inclined portions, and a second substrate having a plurality of unit inclined portions formed to engage with the unit inclined portions of the first substrate.

### TECHNICAL FIELD

The present invention relates to an optical device for augmented reality, and more particularly to an optical device for augmented reality that may improve the quality of real object image light by transferring therethrough only polarized light in a specific direction out of the real object image light using a polarizing plate.

### Background Art

Augmented reality (AR) refers to technology that superimposes a virtual image, provided by a computer or the like, on a real image of the real world and then provides a resulting image, thereby providing the virtual image information augmented from visual information of the real world to a user, as is well known.

In order to realize such augmented reality, there is required an optical combiner that enables the simultaneous observation of virtual images and real images of the real world. As such optical combiners, there are known half mirror-type combiners and holographic/diffractive optical element (HOE/DOE)-type combiners.

Half mirror-type combiners have problems in that the transmittance of virtual images is low and it is difficult to provide desirable wearing comfort because the volume and weight thereof are increased to provide a wide field of view. In order to reduce the volume and weight, there have also been proposed technologies such as a Light-guide Optical Element (LOE) in which a plurality of small half-mirrors are disposed inside a waveguide. This technology also has limitations in that the manufacturing process thereof is complicated and also the luminous uniformity thereof may easily be lowered due to manufacturing error because the image light of a virtual image needs to pass through the half-mirrors a number of times inside the waveguide.

Furthermore, HOE/DOE-type combiners generally employ nanostructure gratings or diffraction gratings. Since they are manufactured in a significantly precise process, the technology has limitations in that the manufacturing cost thereof is high and the yield for mass production is low.

Furthermore, due to the difference in diffraction efficiency according to the wavelength band and the incident angle, this technology has limitations in terms of color uniformity and the low sharpness of an image. Holographic/diffractive optical elements are often used in conjunction with waveguides as in the LOEs described above. Accordingly, this technology still has the same problems.

In addition, the conventional optical combiners have limitations in that a virtual image is out of focus when a user changes a focal length when gazing at the real world. In order to overcome this problem, there has been proposed a technology using a prism capable of adjusting the focal length of a virtual image or a variable focus lens capable of electrically controlling the focal length. However, this technology also has problems in that a user needs to perform a separate operation to adjust the focal length and also separate hardware and software are required for controlling the focal length.

In order to overcome the problems of the prior art, the present applicant has developed technology that projects a virtual image onto the retina through the pupil by using a reflective unit in the form of a pin mirror having a smaller size than the human pupil (see prior art document 1).

FIG. 1 is a diagram showing an optical device 100 for augmented reality as described in prior art document 1.

The optical device 100 for augmented reality shown in FIG. 1 includes an optical means 10, and a reflective unit 20.

An image output unit 30 is a means for outputting virtual image light. For example, the image output unit 30 may include a micro-display unit configured to display a virtual image on a screen and output virtual image light corresponding to the displayed virtual image, and a collimator configured to collimate the image light, output from the micro-display unit, into parallel light and output the parallel light.

The optical means 10 functions to transmit real object image light, which is image light output from an object in the real world, therethrough toward the pupil 40 and output the virtual image light, which is reflected by the reflective unit 20, to the pupil 40.

The optical means 10 may be made of, for example, a transparent resin material like a glasses lens, and may be fixed by a frame (not shown) such as a glasses frame.

The reflective unit 20 functions to transfer the virtual image light, output from the image output unit 30, toward the pupil 40 of a user by reflecting the virtual image light.

The reflective unit 20 is embedded and disposed inside the optical means 10.

The reflective unit 20 of FIG. 1 is formed to have a smaller size than a human pupil. Since it is known that the size of the average pupil of people is about 4 to 8 mm, the reflective unit 20 is formed to have a size of preferably 8 mm or less, more preferably 4 mm or less.

By forming the reflective unit 20 to have a size of 8 mm or less, the depth of field for light entering the pupil 40 through the reflective unit 20 may be made almost infinite, i.e., considerably deep.

In this case, the depth of field refers to a range within which an image for augmented reality is recognized as being in focus. As the depth of field increases, the range of focal lengths for virtual images widens correspondingly. Accordingly, even when a user changes the focal length for the real world while gazing at the real world, the user always recognizes an image for augmented reality as being in focus regardless of such a change. This may be viewed as a type of pinhole effect.

Therefore, a user may always view a clear virtual image even when the user changes the focal length for a real object.

FIGS. 2 to 4 are diagrams showing an optical device 200 for augmented reality as disclosed in prior art document 2, wherein FIG. 2 is a side view thereof, FIG. 3 is a perspective view thereof, and FIG. 4 is a front view thereof.

The optical device 200 for augmented reality shown in FIGS. 2 to 4 has the same basic principle as the optical device 100 for augmented reality shown in FIG. 1, except that, in order to expand a field of view and an eyebox, a reflective unit 20 is composed of a plurality of reflective modules and disposed inside an optical means 10 in an array form, and the virtual image light output from an image output unit 30 is reflected by total internal reflection inside the optical means 10 and transferred to the reflective unit 20.

In FIGS. 2 to 4, reference numerals 21 to 26 denote only the reflective modules seen from the side as shown in FIG. 2, and the reflective unit 20 collectively refers to all of the plurality of reflective modules.

As described above, each of the plurality of reflective modules is formed to have a size of preferably 8 mm or less, more preferably 4 mm or less.

In FIGS. 2 to 4, the virtual image light output from the image output unit 30 is reflected by total internal reflection (TIR) on the inner surface of the optical means 10 and then transferred to the reflective modules, and the reflective modules transfer the incident virtual image light to the pupil 40 by reflecting it.

Therefore, the reflective modules each need to be disposed to have an appropriate inclination angle inside the optical means 10, as shown in the drawing, by taking into consideration the locations of the image output unit 30 and the pupil 40.

The optical means 10 of the optical device 200 for augmented reality may be formed through the following process.

FIGS. 5 to 7 are diagrams illustrating a process of manufacturing the optical means 10.

First, as shown in FIG. 5(a), a first substrate 10A and a second substrate 10B constituting the optical means 10 are formed.

The first substrate 10A and the second substrate 10B have pluralities of unit inclined portions 15 that are formed to engage with each other. The cross section of each of the unit inclined portions 15 has a sawtooth shape, and accordingly has two inclined surfaces 151 and 152 that share one vertex.

However, this is an example, and the profiles such as the shape, size, and height of the unit inclined portions 15 may vary depending on the required design requirements of the optical device 200 for augmented reality.

For example, as shown in FIG. 6, the first substrate 10A and the second substrate 10B may be formed by injecting an ultraviolet-curable resin 17 into a mold 80 having a shape corresponding to the shape of the unit inclined portions 15 and then curing the ultraviolet-curable resin 17 through the radiation of ultraviolet rays thereonto. However, this is an example. It is obvious that other methods such as injection molding may be used in addition to the above method.

Once the first substrate 10A and the second substrate 10B have been formed, the reflective modules 21 to 26 are formed on one type of reflective surfaces 151 of the inclined surfaces 151 and 152 of the unit inclined portions 15 of the first substrate 10A, as shown in FIG. 5(b).

Although the reflective modules 21 to 26 are formed only on the right inclined surfaces 151 in FIG. 5, this is an example. It is obvious that depending on the required requirements of the optical device 200 for augmented reality, the reflective modules 21 to 26 may be formed only on the left inclined surfaces 152.

Alternatively, the reflective modules 21 to 26 may be formed on the inclined surfaces 151 of the second substrate 10B.

Furthermore, as shown in FIG. 7, the plurality of reflective modules are formed to be spaced apart from each other along the longitudinal direction in which each of the inclined surfaces 151 extends, thereby allowing the reflective modules to be arranged in an array form, as shown in FIGS. 2 to 4.

The reflective modules may be formed, for example, by a method of depositing a metal material using a mask.

After the reflective modules have been formed, the optical means 10 is completed by tightly bonding the first substrate 10A and the second substrate 10B to each other by, for example, an adhesive 16, as shown in FIG. 5(c).

By arranging this optical means 10 to be in front of the pupil 40 in the form shown in FIG. 2 and disposing the image output 30 on top of the optical means 10, the optical device 200 for augmented reality may be obtained.

However, this optical device 200 for augmented reality tightly couples the first substrate 10A and the second substrate 10B to each other by using the adhesive 16. Accordingly, due to the difference in refractive index between the adhesive 16 and the first and second substrates 10A and 10B, a deterioration in the quality of real object image light may occur.

Furthermore, the inclined surfaces 151 and 152 of the unit inclined portions 15 of the first and second substrates 10A and 10B are formed to be inclined with respect to a straight line in the forward direction from the pupil 40. Accordingly, when real object image light passes through the inclined surfaces 151 and 152, it is influenced by the inclined surfaces 151 and 152, so that a problem arises in that the influence may cause a deterioration in the quality of the real object image light.

### Prior Art Literature

(Prior art document 1) Korean Patent Application Publication No. 10-2018-0028339 (published on Mar. 16, 2018)

(Prior art document 2) Korean Patent No. 10-2192942 (published on Dec. 18, 2020)

### DISCLOSURE

### Technical Problem

An object of the present invention is to provide an optical device for augmented reality that may improve the quality of real object image light by transferring therethrough only polarized light in a specific direction out of the real object image light using a polarizing plate.

### Technical Solution

In order to accomplish the above object, the present invention provides an optical device for augmented reality including a polarizing plate, the optical device including: an optical means for transferring real object image light, output from a real object, to the pupil of an eye of a user by transmitting it therethrough; a reflective unit embedded and disposed inside the optical means, and formed of a plurality of reflective modules that provide a virtual image to the user by transferring virtual image light, transferred from an image output unit, to the pupil of the eye of the user; and a polarizing plate configured to transmit therethrough only a polarization component in a first direction out of the real object image light; wherein the optical means has a first substrate having a plurality of unit inclined portions, and a second substrate having a plurality of unit inclined portions formed to engage with the unit inclined portions of the first substrate; wherein reflective modules are disposed on inclined surfaces of the unit inclined portions of any one of the first and second substrates of the optical means; wherein the optical means is disposed in front of the pupil so that the inclined surfaces of the unit inclined portions are inclined with respect to a forward direction from the pupil; and wherein the polarization component in the first direction transmitted therethrough by the polarizing plate is polarized light in any direction, within the range of 0 to ±30 degrees with respect to a direction perpendicular to a longitudinal direction in which the inclined surfaces extend and a direction perpendicular to the forward direction from the pupil, out of the actual object image light.

In this case, the optical means may be disposed in front of the pupil so that, when the forward direction from the pupil is set to the z axis, a straight line parallel to the longitudinal direction in which the inclined surfaces of the unit inclined portions extend is included in a plane perpendicular to the z axis, and, when the longitudinal direction in which the inclined surfaces extend is set to the x axis, the first direction may be any one direction within the range of 0 to ±30 degrees with respect to the y-axis direction, which is a direction perpendicular to the x axis and the z axis.

Furthermore, the polarizing plate may be disposed inside or outside the optical means.

Furthermore, the optical means may have a first surface configured such that virtual image light and real object image light are output toward the pupil of the user therethrough and a second surface disposed opposite the first surface and configured such that real object image light enters therethrough, and the polarizing plate may be disposed in close contact with or at a distance from the first or second surface.

Furthermore, the optical means may be disposed such that the inclined surfaces of the unit inclined portions each have an inclination angle with respect to a straight line horizontal to the z axis.

Furthermore, the plurality of reflective modules may be formed to have a size of 4 mm or less.

According to another aspect of the present invention, there is provided an optical device for augmented reality including a polarizing plate, the optical device including: an optical means for transferring real object image light, output from a real object, to the pupil of an eye of a user by transmitting it therethrough; an auxiliary optical unit embedded and disposed inside the optical means, and configured to convert virtual image light, transferred from an image output unit, into collimated light and output it; a reflective unit embedded and disposed inside the optical means, and formed of a plurality of reflective modules that provide a virtual image to the user by transferring the virtual image light, transferred from the auxiliary optical unit, to the pupil of the eye of the user; and a polarizing plate configured to transmit therethrough only a polarization component in a first direction out of the real object image light; wherein the optical means has a first substrate having a plurality of unit inclined portions, and a second substrate having a plurality of unit inclined portions formed to engage with the unit inclined portions of the first substrate; wherein reflective modules are disposed on inclined surfaces of the unit inclined portions of any one of the first and second substrates of the optical means; wherein the optical means is disposed in front of the pupil so that the inclined surfaces of the unit inclined portions are inclined with respect to a forward direction from the pupil; and wherein the polarization component in the first direction transmitted therethrough by the polarizing plate is polarized light in any direction, within the range of 0 to ±30 degrees with respect to a direction perpendicular to a longitudinal direction in which the inclined surfaces extend and a direction perpendicular to the forward direction from the pupil, out of the actual object image light.

In this case, the optical means may be disposed in front of the pupil so that, when the forward direction from the pupil is set to the z axis, a straight line parallel to the longitudinal direction in which the inclined surfaces of the unit inclined portions extend is included in a plane perpendicular to the z axis; and, when the longitudinal direction in which the inclined surfaces extend is set to the x axis, the first direction may be any one direction within the range of 0 to ±30 degrees with respect to the y-axis direction, which is a direction perpendicular to the x axis and the z axis.

Furthermore, the polarizing plate may be disposed inside or outside the optical means.

Furthermore, the optical means may have a first surface configured such that virtual image light and real object image light are output toward the pupil of the user therethrough and a second surface disposed opposite the first surface and configured such that real object image light enters therethrough, and the polarizing plate may be disposed in close contact with or at a distance from the first or second surface.

Furthermore, the optical means may be disposed such that the inclined surfaces of the unit inclined portions each have an inclination angle with respect to a straight line horizontal to the z axis.

Furthermore, the plurality of reflective modules may be formed to have a size of 4 mm or less.

Furthermore, the optical means may have a first surface configured such that virtual image light and real object image light are output toward the pupil of the user therethrough, and a second surface disposed opposite the first surface and configured such that real object image light enters therethrough, and the reflective surface of the auxiliary optical unit that reflects incident virtual image light may be disposed to be directed toward the first or second surface of the optical means.

Furthermore, when the optical means is viewed in the forward direction from the pupil, the auxiliary optical unit may be formed to become closer to the image output unit as it extends from the central portion thereof toward both left and right ends thereof.

### ADVANTAGEOUS EFFECTS

According to the present invention, there may be provided the optical device for augmented reality that may improve the quality of real object image light by transferring therethrough only polarized light in a specific direction out of the real object image light using the polarizing plate.

### DESCRIPTION OF DRAWINGS

FIG. 1 is a diagram showing an optical device (100) for augmented reality as described in prior art document 1;

FIGS. 2 to 4 are diagrams showing an optical device (200) for augmented reality as disclosed in prior art document 2, wherein FIG. 2 is a side view thereof, FIG. 3 is a perspective view thereof, and FIG. 4 is a front view thereof;

FIGS. 5 to 7 are diagrams illustrating a process of manufacturing an optical means (10);

FIGS. 8 to 10 are diagrams illustrating an optical device (300) for augmented reality including a polarizing plate according to an embodiment of the present invention, wherein FIG. 8 is a side view thereof, FIG. 9 is a perspective view thereof, and FIG. 10 is a front view thereof;

FIGS. 11 to 14 are diagrams illustrating the directionality of polarized light transmitted therethrough by a polarizing plate (50);

FIGS. 15 and 16 are diagrams illustrating the operational effects of the polarizing plate (50); and

FIGS. 17 to 19 are diagrams illustrating an optical device (400) according to another embodiment of the present invention, wherein FIG. 17 is a side view thereof, FIG. 18 is a perspective view thereof, and FIG. 19 is a front view thereof.

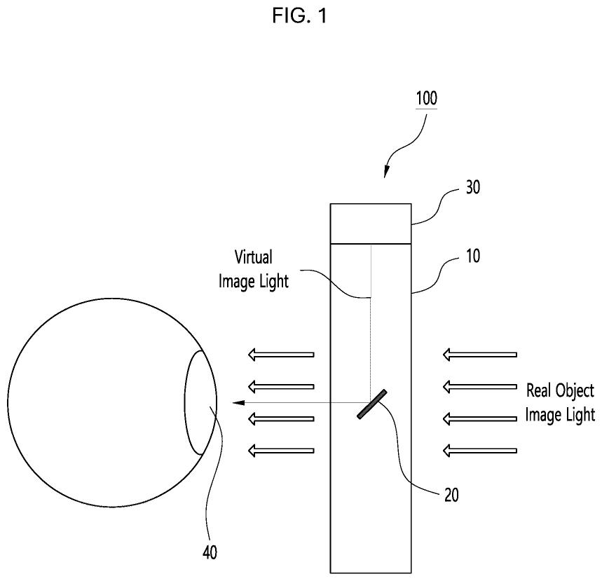

### BEST MODE

Embodiments of the present invention will be described in detail below with reference to the accompanying drawings.

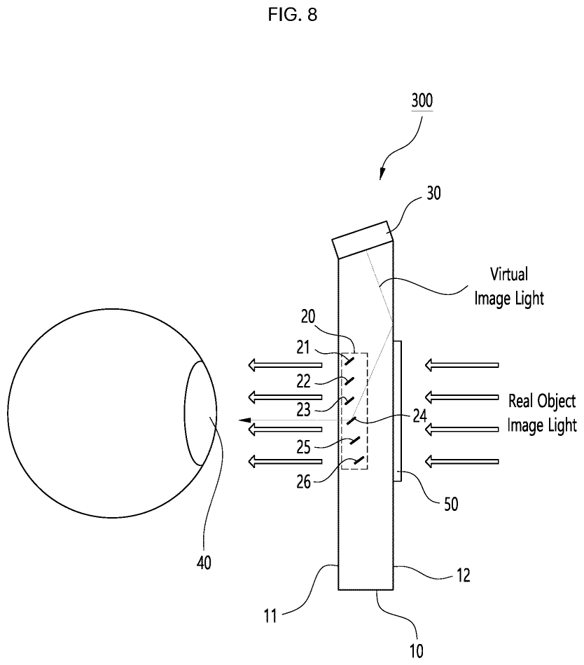

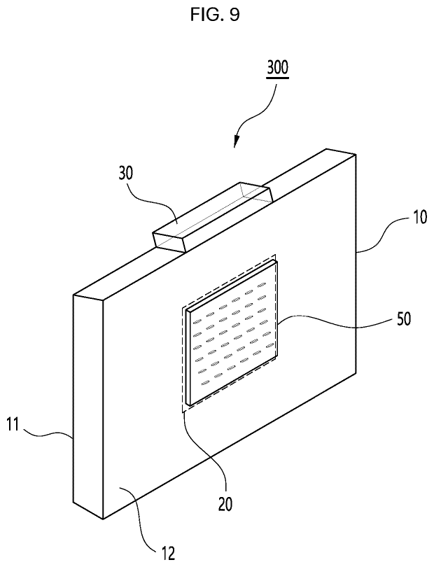

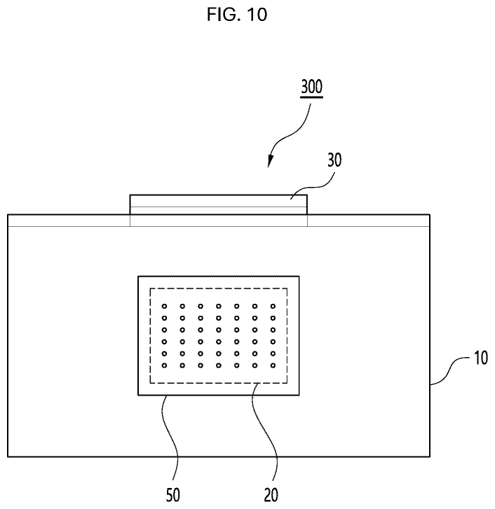

FIGS. 8 to 10 are diagrams illustrating an optical device 300 for augmented reality including a polarizing plate according to an embodiment of the present invention, wherein FIG. 8 is a side view thereof, FIG. 9 is a perspective view thereof, and FIG. 10 is a front view thereof.

Referring to FIGS. 8 to 10, the optical device 300 for augmented reality (hereinafter briefly referred to as the “optical device 300”) including a polarizing plate includes an optical means 10, a reflective unit 20, and a polarizing plate 50.

First, an image output unit 30 will be described.

The image output unit 30 is a means for outputting virtual image light, which is image light corresponding to a virtual image. In this case, the virtual image refers to an image for augmented reality provided to a user, and may be a still image or moving image.

The image output unit 30 may include a display unit implemented with a conventionally known micro-display device such as a small LCD, OLED, LCOS, or micro-LED, or the like, and a collimator configured to collimate the virtual image light output from the display unit and output it as parallel light.

Since the image output unit 30 itself is not a direct target of the present invention and is known in the prior art, a detailed description thereof will be omitted here.

Meanwhile, although the image output unit 30 is shown as being disposed on the top of the optical means 10 in FIGS. 8 to 10, this is an example. It is obvious that the image output unit 30 may be disposed at other locations.

The optical means 10 is a means for transmitting therethrough the real object image light output from a real object present in the real world and transferring it to the pupil 40 of an eye of a user. Furthermore, the virtual image light output from the reflective unit 20 is transferred to the pupil 40 through the optical means 10.

The optical means 10 has a first surface 11 configured such that virtual image light and real object image light are output toward the pupil 40 of the user therethrough, and a second surface 12 disposed opposite the first surface 11 and configured such that real object image light enters therethrough.

The reflective unit 20 including a plurality of reflective modules is embedded in the optical means 10 to be spaced apart from the first and second surfaces 11 and 12.

The reflective unit 20 is a means for providing a virtual image to the user by transferring the virtual image light, transferred from the image output unit 30, to the pupil 40 of the eye of the user.

As shown in the drawing, the reflective unit 20 includes a plurality of reflective modules arranged in a matrix form when viewed from the front.

In FIGS. 8 to 10, reference numerals 21 to 26 denote only the reflective modules seen from the side as shown in FIG. 8, and the reflective unit 20 collectively refers to all of the plurality of reflective modules.

The plurality of reflective modules constituting the reflective unit 20 are embedded and disposed inside the optical means 10. That is, the reflective modules are disposed in the internal space of the optical means 10 to be spaced apart from the first and second surfaces 11 and 12 and top and bottom surfaces of the optical means 10.

In the optical device 300, the virtual image light output from the image output unit 30 is output toward the second surface 12 of the optical means 10, is reflected by internal total reflection on the second surface 12 of the optical means 10, and is then transferred to the plurality of reflective modules. Accordingly, each of the reflective modules is disposed to have an appropriate inclination angle inside the optical means 10 by taking into consideration the above optical path.

Meanwhile, as described above, each of the plurality of reflective modules is preferably formed to be smaller than the size of the human pupil, i.e., 8 mm or less, more preferably 4 mm or less, in order to obtain a pinhole effect by increasing the depth of field.

Accordingly, the depth of field for the light incident onto the pupil 40 may be made almost infinite, i.e., considerably deep, by the reflective modules. Therefore, there may be achieved a pinhole effect that allows a virtual image to be always recognized as being in focus regardless of a change in the focal length even when a user changes the focal length for the real world while gazing at the real world.

In this case, the size of each of the reflective modules is defined as the maximum length between any two points on the edge boundary line of each reflective module.

Furthermore, the size of each of the reflective modules may be the maximum length between any two points on the edge boundary of an orthographic projection obtained by projecting each reflective module onto a plane that is perpendicular to a straight line between the pupil 40 and the reflective modules and includes the center of the pupil 40.

Meanwhile, when the size of the reflective modules is excessively small, a diffraction phenomenon increases, so that the size of each of the reflective modules is preferably larger than, for example, 0.3 mm.

Furthermore, the shape of each of the reflective modules may be circular.

Furthermore, each of the reflective modules may be formed in an elliptical shape so that it appears circular when viewed from the pupil 40.

Meanwhile, each of the reflective modules is disposed to prevent the virtual image light transferred from the image output unit 30 from being blocked by other reflective modules. To this end, as shown in FIG. 8, when the optical device 300 is viewed from the side, the plurality of reflective modules may not be arranged side by side on a vertical line, but may be arranged in a diagonal line or a gently curved shape.

Meanwhile, the reflective modules are preferably made of a metal material having a high reflectance of 100% or close to 100%.

Furthermore, instead of the reflective modules, half mirrors that partially reflect light and partially transmit light therethrough may be used.

Furthermore, instead of each of the reflective modules, any one or a combination of a refractive optical element, a diffractive optical element (DOE), and a holographic optical element (HOE) may be used.

The polarizing plate 50 is a means for transmitting therethrough only a polarization component in a first direction out of the real object image light output from a real object.

The polarizing plate 50 may be disposed inside or outside the optical means 10.

Although the polarizing plate 50 is disposed outside the optical means 10, i.e., on the outside of the second surface 12, in FIGS. 8 to 10, this is an example. The polarizing plate 50 may also be disposed on the outside of the first surface 11 of the optical means 10.

Furthermore, the polarizing plate 50 may be disposed inside the optical means 10, i.e., on the inside of the second or first surface 12 or 11 of the optical means 10.

Furthermore, although the polarizing plate 50 may be disposed in close contact with the first or second surface 11 or 12 of the optical means 10, the polarizing plate 50 may also be disposed at a distance from the first or second surface 11 or 12.

The polarizing plate 50 transmits therethrough only a polarization component in the first direction out of incident real object image light. In this case, the first direction refers to a specific direction determined according to the arrangement relationship of the optical means 10 with the pupil 40, as will be described later.

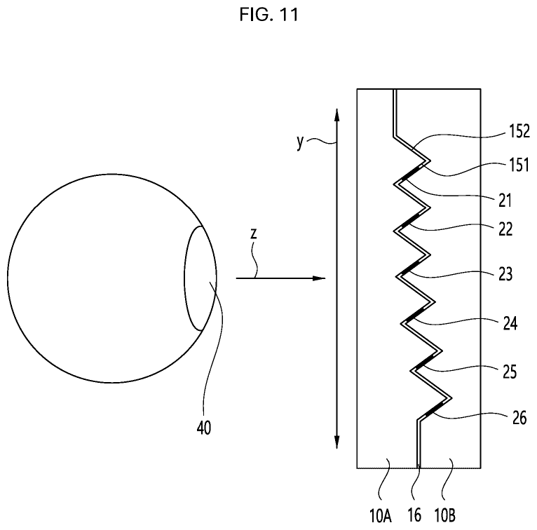

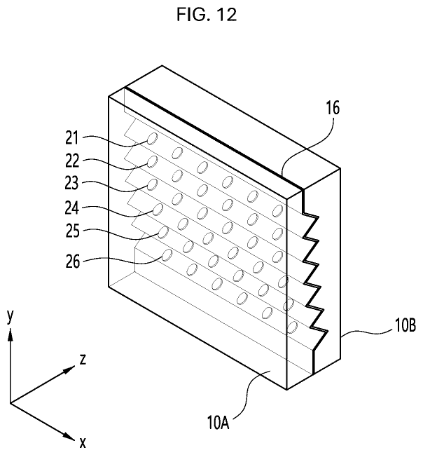

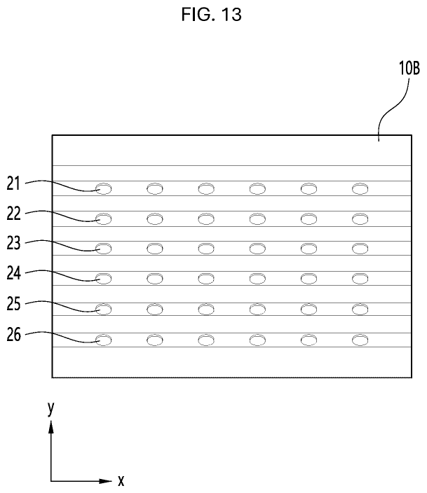

FIGS. 11 to 14 are diagrams illustrating the arrangement relationship between the direction of polarized light transmitted therethrough by the polarizing plate 50 and the optical means 10.

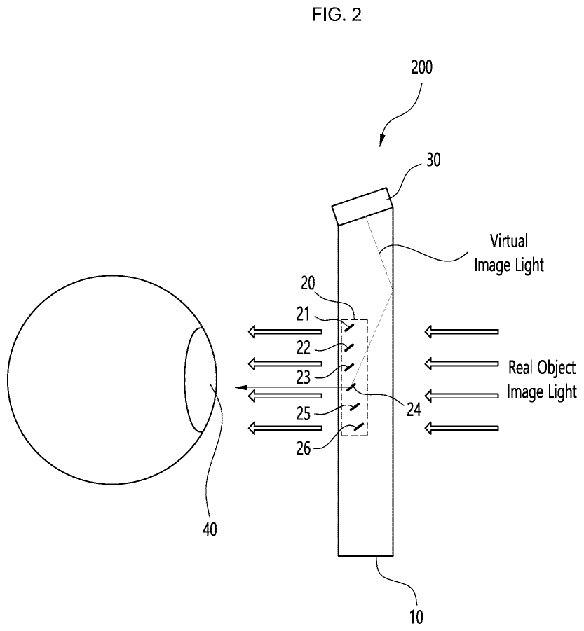

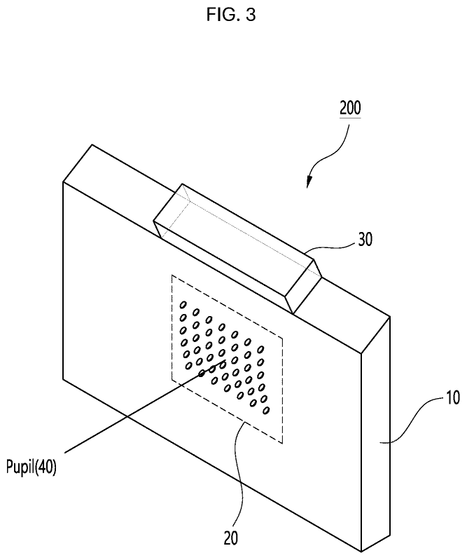

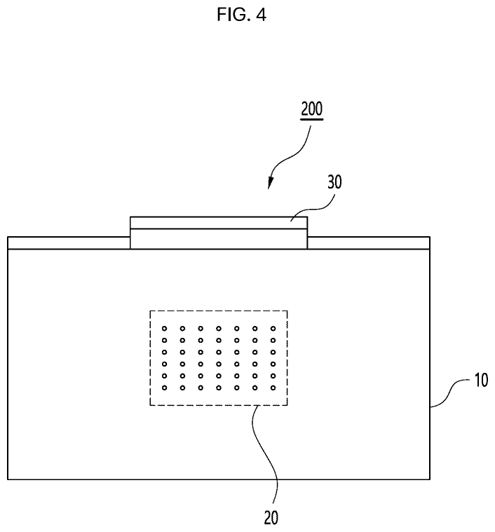

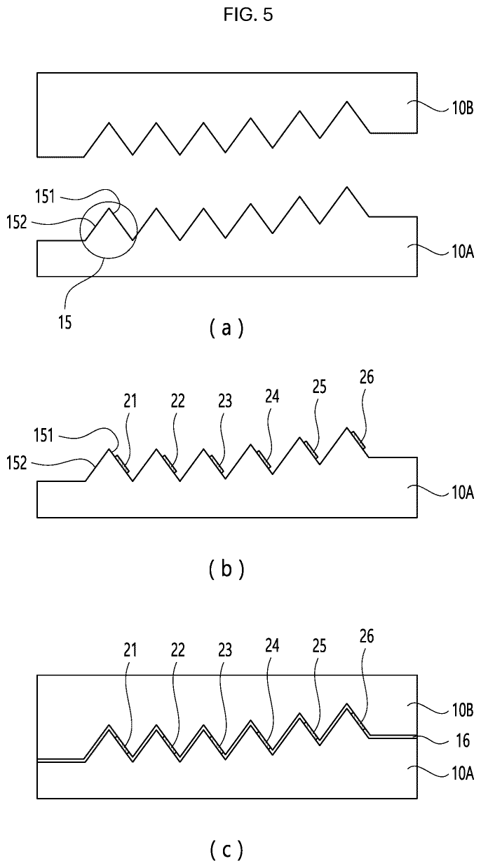

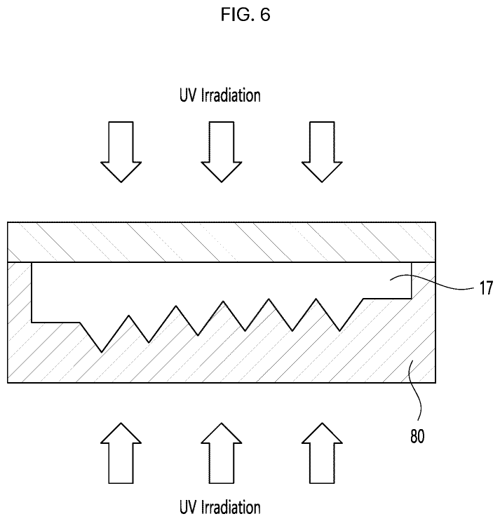

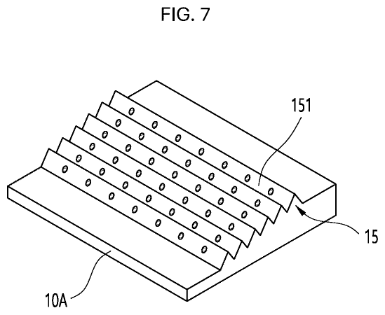

First, the optical means 10 is formed by forming first and second substrates 10A and 10B having pluralities of unit inclined portions 15 formed to engage with each other, forming a plurality of reflective modules on any one type of inclined surfaces 151 of the two types of inclined surfaces 151 and 152 of the unit inclined portions 15 of the first substrate 10A, and tightly coupling the first and second substrates 10A and 10B to each other, as previously described in the background technology section with reference to FIGS. 2 to 7.

That is, the optical means 10 includes the first substrate 10A having the plurality of unit inclined portions 15, and the second substrate 10B having the plurality of unit inclined portions 15 formed to engage with the unit inclined portions 15 of the first substrate 10B. In this case, the cross section of each of the unit inclined portions 15 has a sawtooth shape and has two inclined surfaces 151 and 152. The two slopes 151 and 152 may share one vertex.

In this case, the reflective modules are disposed on any one type of surfaces 151 of the two types of inclined surfaces 151 and 152 of the individual unit inclined portions 15 of the first substrate 10A. Furthermore, a plurality of reflective modules are arranged to be spaced apart from each other along the longitudinal direction in which the inclined surface 151 of each of the unit inclined portions 15 extends.

The optical means 10 is completed by tightly coupling the first substrate 10A and the second substrate 10B to each other by using, for example, an adhesive 16.

The optical means 10 formed in this way is disposed in front of the pupil 40 so that the inclined surfaces 151 and 152 of the unit inclined portions 15 are inclined with respect to the forward direction from the pupil 40.

In this case, the polarization component in the first direction transmitted therethrough by the polarizing plate 50 is polarized light in any direction, within the range of 0 to ±30 degrees with respect to the direction perpendicular to the longitudinal direction in which the inclined surfaces 151 and 152 extend and the direction perpendicular to the forward direction from the pupil 40, out of real object image light.

That is, as shown in FIGS. 11 to 13, the optical means 10 is disposed in front of the pupil 40 so that when the forward direction from the pupil 40 is set to the z axis, a straight line parallel to the longitudinal direction in which the inclined surfaces 151 and 152 of the unit inclined portions 15 extend is included in a plane perpendicular to the z axis.

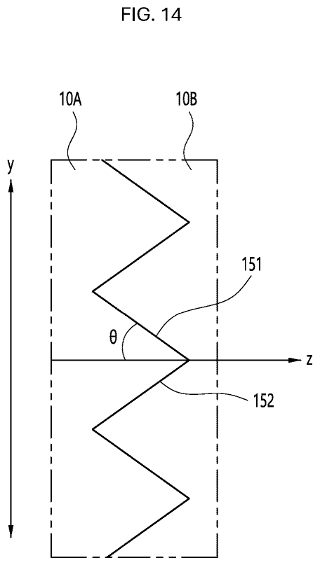

In other words, the optical means 10 is disposed such that the inclined surfaces 151 of the unit inclined portions 15 of the optical means 10 each have an inclination angle θ with respect to a straight line horizontal to the z axis when viewed from the side, as shown in FIG. 14.

In this case, the inclination angles of the inclined surface 151 and the inclined surface 152 with respect to a straight line horizontal to the z axis may be different from each other.

In this case, when the longitudinal direction in which the inclined surfaces 151 extend is set to the x axis, the direction of polarized light transmitted therethrough by the polarizing plate 50, i.e., the first direction, may be any one direction within the range of 0 to ±30 degrees with respect to the y-axis direction, which is a direction perpendicular to the x axis and the z axis.

Through this polarizing plate 50, only the polarization component vibrating in the first direction out of the real object image light is transmitted through the polarizing plate 50. Accordingly, the polarizing plate 50 functions as a polarizing filter that transmits therethrough only a polarization component in the first direction out of real object image light.

For example, when the polarization in the first direction is called s polarization, the polarizing plate 50 transmits therethrough only an s-polarization component out of real object image light.

Since the polarizing plate 50 itself is not a direct target of the present invention and various other components known in the prior art may be used, a detailed description thereof will be omitted.

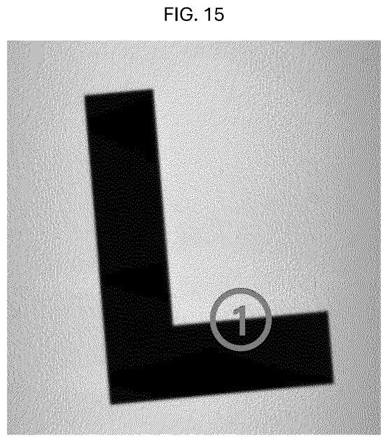

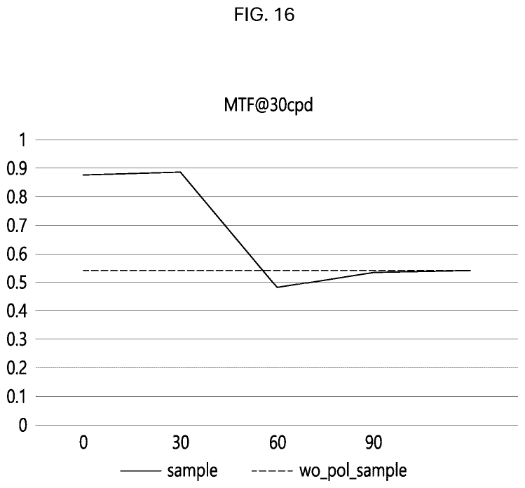

FIGS. 15 and 16 are diagrams illustrating the operational effects of the polarizing plate 50.

FIG. 15 is a sample image, and FIG. 16 shows MTF (Modulation Transfer Function) result values for portion \textcircled{1} of the sample image of FIG. 15.

In FIG. 16, the x axis represents the angle of the first direction of the polarizing plate 50, and the y axis represents the MTF result value for portion \textcircled{1} of the sample image.

Furthermore, in FIG. 16, the solid line represents the MTF result of the optical device 300 with the polarizing plate 50, and the dotted line represents the MTF result of the optical device 200 without the polarizing plate 50.

As shown in the drawing, it can be seen that when the first direction is in the range of 0 to 30 degrees, the optical device 300 with the polarizing plate 50 has a significantly higher MTF result than the optical device 200 without the polarizing plate 50.

Accordingly, it can be seen that when the polarizing plate 50 described above is disposed in a component such as the optical device 200, the quality of real object image light may be significantly improved.

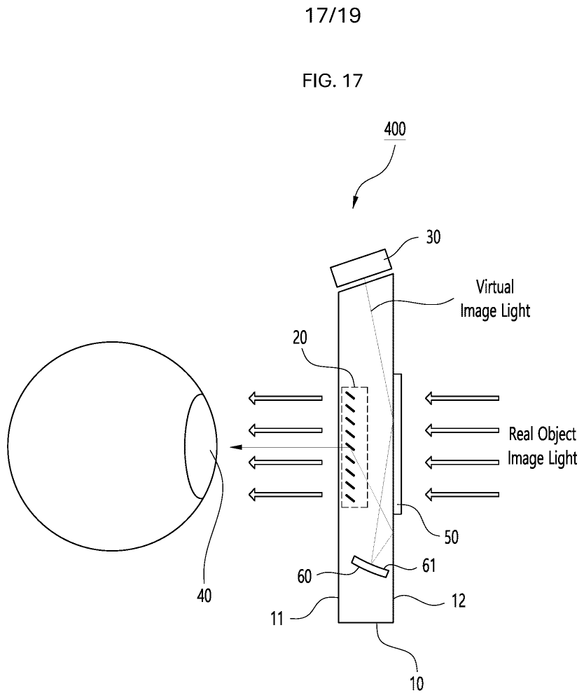

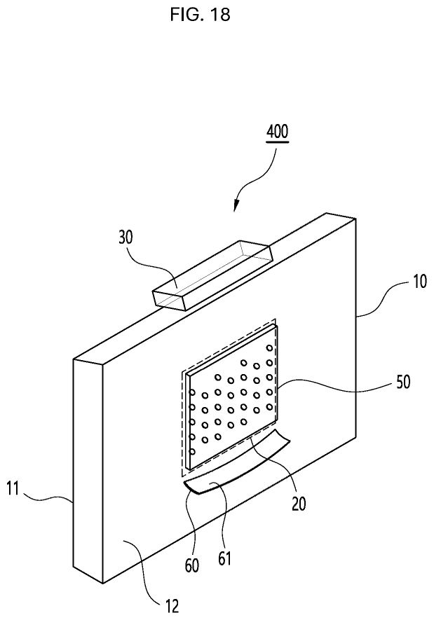

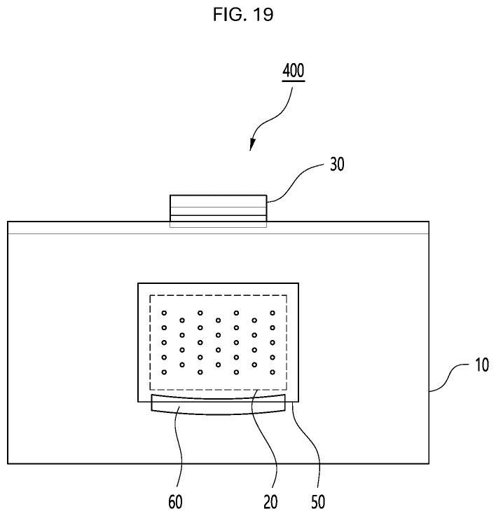

FIGS. 17 to 19 are diagrams illustrating an optical device 400 according to another embodiment of the present invention, wherein FIG. 17 is a side view thereof, FIG. 18 is a perspective view thereof, and FIG. 19 is a front view thereof.

The optical device 400 of FIGS. 17 to 19 is basically the same as the optical device 300 described with reference to FIGS. 8 to 16, except that an auxiliary optical unit 60 configured to perform the function of a collimator is embedded and disposed in the optical means 10. Accordingly, the image output unit 30 of the optical device 400 does not include a component such as a collimator, which provides the advantage of reducing the form factor of the optical device 400.

The auxiliary optical unit 60 functions to convert the virtual image light output from the image output unit 30 into collimated parallel light and output it. Accordingly, the virtual image light output from the auxiliary optical unit 60 is collimated parallel light or image light having an intended focal length.

The auxiliary optical unit 60 is preferably implemented as a reflective means for reflecting incident virtual image light and outputting it as collimated parallel light.

As shown in the drawing, the auxiliary optical unit 60 is embedded and disposed inside the optical means 10 to face the image output unit 30.

Referring to FIG. 18, the image output unit 30 outputs virtual image light toward the second surface 12 of the optical means 10, and the virtual image light reflected by total internal reflection on the second surface 12 of the optical means 10 is transferred to the auxiliary optical unit 60.

The auxiliary optical unit 60 converts incident virtual image light into collimated parallel light and outputs it, and the output collimated parallel light is reflected by total internal reflection again on the second surface 12 of the optical means 10 and is then transferred to the reflective unit 20.

The reflective unit 20 including a plurality of reflective modules reflects the incident virtual image light and transfers it to the pupil 40, as described in conjunction with the above-described embodiment.

Therefore, the auxiliary optical unit 60 is disposed at an appropriate location inside the optical means 10 between the first and second surfaces 11 and 12 of the optical means 10 by taking into consideration the relative locations of the image output unit 30, the reflective unit 20, and the pupil 40.

In the optical device 400, the auxiliary optical unit 60 is embedded and disposed inside the optical means 10 so that the reflective surface 61 from which virtual image light is reflected and output is directed toward the second surface 12 of the optical means 10.

In this case, a straight line in the vertical direction from the center of the reflective surface 61 and the second surface 12 of the optical means 10 may be inclined to each other so that they are not parallel to each other.

However, this is an example. It will be obvious that the auxiliary optical unit 60 is embedded and disposed inside the optical means 10 so that the reflective surface 61 of the auxiliary optical unit 60 is directed toward the first surface 11 of the optical means 10.

Meanwhile, the reflective surface 61 of the auxiliary optical unit 60 may be formed as a curved surface. For example, the reflective surface 61 of the auxiliary optical unit 60 may be formed to be concave in the direction of the second surface 12 of the optical means 10, as shown in the drawing.

With this configuration, the auxiliary optical unit 60 may function as a collimator for collimating virtual image light. Accordingly, there is no need to use a component such as a collimator in the image output unit 30.

Furthermore, it is preferable that the auxiliary optical unit 60 appears thin when a user looks straight ahead through the pupil 40 so that the user rarely recognizes it.

Meanwhile, the auxiliary optical unit 60 may be composed of a means such as a half mirror for partially reflecting light.

Furthermore, the auxiliary optical unit 60 may be formed of a refractive or diffractive element other than a reflective means, or may be formed of a combination of at least one thereof.

Meanwhile, as shown in the drawing, when the optical means 10 is viewed in the forward direction from the pupil 40, the auxiliary optical unit 60 may be formed to become closer to the image output unit 30 as it extends from the central portion thereof toward both left and right ends thereof.

That is, the auxiliary optical unit 60 may be formed in the overall shape of a gentle “U”-shaped bar when viewed from the front thereof. This may further improve the function of the auxiliary optical unit 60 serving as a collimator.

Since other components in the embodiments of FIGS. 17 to 19 are the same as those in the embodiments described above, detailed descriptions thereof will be omitted.

Although the present invention has been described above with reference to preferred embodiments of the present invention, these are examples. It should be noted that all modifications within the scope of equivalents determined by the appended claims and drawings are included within the scope of the present invention.

1. An optical device for augmented reality including a polarizing plate, the optical device comprising:
an optical means for transferring real object image light, output from a real object, to a pupil of an eye of a user by transmitting it therethrough;
a reflective unit embedded and disposed inside the optical means, and formed of a plurality of reflective modules that provide a virtual image to the user by transferring virtual image light, transferred from an image output unit, to the pupil of the eye of the user; and
a polarizing plate configured to transmit therethrough only a polarization component in a first direction out of the real object image light;
wherein the optical means has a first substrate having a plurality of unit inclined portions, and a second substrate having a plurality of unit inclined portions formed to engage with the unit inclined portions of the first substrate;
wherein reflective modules are disposed on inclined surfaces of the unit inclined portions of any one of the first and second substrates of the optical means;
wherein the optical means is disposed in front of the pupil so that the inclined surfaces of the unit inclined portions are inclined with respect to a forward direction from the pupil; and
wherein the polarization component in the first direction transmitted therethrough by the polarizing plate is polarized light in any direction, within a range of 0 to ±30 degrees with respect to a direction perpendicular to a longitudinal direction in which the inclined surfaces extend and a direction perpendicular to the forward direction from the pupil, out of the actual object image light.

2. The optical device of claim 1, wherein:
the optical means is disposed in front of the pupil so that, when the forward direction from the pupil is set to a z axis, a straight line parallel to the longitudinal direction in which the inclined surfaces of the unit inclined portions extend is included in a plane perpendicular to the z axis; and
when the longitudinal direction in which the inclined surfaces extend is set to an x axis, the first direction is any one direction within a range of 0 to ±30 degrees with respect to a y-axis direction, which is a direction perpendicular to the x axis and the z axis.

3. The optical device of claim 1, wherein the polarizing plate is disposed inside or outside the optical means.

4. The optical device of claim 3, wherein:
the optical means has a first surface configured such that virtual image light and real object image light are output toward the pupil of the user therethrough, and a second surface disposed opposite the first surface and configured such that real object image light enters therethrough; and
the polarizing plate is disposed in close contact with or at a distance from the first or second surface.

5. The optical device of claim 1, wherein the optical means is disposed such that the inclined surfaces of the unit inclined portions each have an inclination angle with respect to a straight line horizontal to the z axis.

6. The optical device of claim 1, wherein the plurality of reflective modules are formed to have a size of 4 mm or less.

7. An optical device for augmented reality including a polarizing plate, the optical device comprising:
an optical means for transferring real object image light, output from a real object, to a pupil of an eye of a user by transmitting it therethrough;
an auxiliary optical unit embedded and disposed inside the optical means, and configured to convert virtual image light, transferred from an image output unit, into collimated light and output it;
a reflective unit embedded and disposed inside the optical means, and formed of a plurality of reflective modules that provide a virtual image to the user by transferring the virtual image light, transferred from the auxiliary optical unit, to the pupil of the eye of the user; and
a polarizing plate configured to transmit therethrough only a polarization component in a first direction out of the real object image light;
wherein the optical means has a first substrate having a plurality of unit inclined portions, and a second substrate having a plurality of unit inclined portions formed to engage with the unit inclined portions of the first substrate;
wherein reflective modules are disposed on inclined surfaces of the unit inclined portions of any one of the first and second substrates of the optical means;
wherein the optical means is disposed in front of the pupil so that the inclined surfaces of the unit inclined portions are inclined with respect to a forward direction from the pupil; and
wherein the polarization component in the first direction transmitted therethrough by the polarizing plate is polarized light in any direction, within a range of 0 to ±30 degrees with respect to a direction perpendicular to a longitudinal direction in which the inclined surfaces extend and a direction perpendicular to the forward direction from the pupil, out of the actual object image light.

8. The optical device of claim 7, wherein:
the optical means is disposed in front of the pupil so that, when the forward direction from the pupil is set to a z axis, a straight line parallel to the longitudinal direction in which the inclined surfaces of the unit inclined portions extend is included in a plane perpendicular to the z axis; and
when the longitudinal direction in which the inclined surfaces extend is set to an x axis, the first direction is any one direction within a range of 0 to ±30 degrees with respect to a y-axis direction, which is a direction perpendicular to the x axis and the z axis.

9. The optical device of claim 7, wherein the polarizing plate is disposed inside or outside the optical means.

10. The optical device of claim 9, wherein:
the optical means has a first surface configured such that virtual image light and real object image light are output toward the pupil of the user therethrough, and a second surface disposed opposite the first surface and configured such that real object image light enters therethrough; and
the polarizing plate is disposed in close contact with or at a distance from the first or second surface.

11. The optical device of claim 7, wherein the optical means is disposed such that the inclined surfaces of the unit inclined portions each have an inclination angle with respect to a straight line horizontal to the z axis.

12. The optical device of claim 7, wherein the plurality of reflective modules are formed to have a size of 4 mm or less.

13. The optical device of claim 7, wherein:
the optical means has a first surface configured such that virtual image light and real object image light are output toward the pupil of the user therethrough, and a second surface disposed opposite the first surface and configured such that real object image light enters therethrough; and
a reflective surface of the auxiliary optical unit that reflects incident virtual image light is disposed to be directed toward the first or second surface of the optical means.

14. The optical device of claim 7, wherein, when the optical means is viewed in the forward direction from the pupil, the auxiliary optical unit is formed to become closer to the image output unit as it extends from a central portion thereof toward both left and right ends thereof.
